(19) United States
(12) Patent Application Publication
(10) Pub. No.: US 2011/0303610 A1
(43) Pub. Date: Dec. 15, 2011

(54) VESSEL AND METHOD FOR TRAPPING A SUBSTANCE

(76) Inventor: Nitin Shivajirao Udar, La Mirada, CA (US)

(21) Appl. No.: 13/160,491

(22) Filed: Jun. 14, 2011

Related U.S. Application Data
(60) Provisional application No. 61/354,481, filed on Jun. 14, 2010.

(51) Int. Cl. B01D 15/14; B01L 3/02; B01L 3/08; B01L 3/00; B01L 3/14

(52) U.S. Cl. 210/663; 210/767; 422/547; 422/550; 422/552; 422/556; 422/524

(57) ABSTRACT

The present invention provides a vessel with a textured inner surface and methods of using the vessel to trap aggregated substances. The vessel facilitates the separation of the substance from surrounding media. The present invention relates to vessels with a textured inner surface and methods of using such vessels for the separation of a trapped aggregated target substance from a media containing one or more other substances.

This is application claims priority to U.S. Provisional Patent Application No. 61/354,481, filed Jun. 14, 2010, which is incorporated herein in its entirety.

### BACKGROUND

Separation of a target substance from a sample (e.g., media) containing one or more substances is frequently desirable. For example, separation of blood cells from total blood to yield plasma. Plasma can then be collected and stored for future use.

A target substance admixed with media can be separated from the media by many methods. For example, different types of forces such as centrifugal force, magnetic field, electric field or a binding force can be applied to a media held in a vessel. The force on the media containing the target substance separates the target substance from the media. During the application of the force to the media for a given length of time, the target substance aggregates on an inner surface of the vessel. When the force that separates the target substance from the media is removed, the target substance will, in time, come apart from the inner surface of the vessel and mix with the media. During a short time period following the application of force, the target substance is in the form of an aggregate that can facilitate its removal from the media in the vessel. However, if the aggregated target substance is not removed in a timely manner, the aggregated target substance separates from the inner surface and mixes back in the media.

In order to ensure that a target substance firmly adheres on the surface of a vessel for its efficient removal from media, protocols require application of force for a given length of time to aggregate the target substance on the inner surface of the vessel. In certain situations and within certain limits, applying a greater force and/or longer time will result in higher compaction of the target substance.

There are several protocols used to separate the target substance from the surrounding media. When multiple samples are processed at the same time, quick response is required so that the aggregate does not come off the inner surface of the vessel before the last sample is handled. Therefore the longer the aggregate remains attached to the inner surface vessel, the more efficient the process. In order to achieve this goal, protocols require a longer and/or greater application of force than is necessary to aggregate the target substance on the inner surface of the vessel. Application of a longer and/or greater force compacts the target substance into a firmer aggregate so that the target substance will stay aggregated for a longer time after cessation of the force. This would result in compromising the sample quality and waste of time.

Disadvantages of the longer and/or greater force aggregating the target substance include damage to the target substance. For example, if the target substance comprises of cells, they can burst upon exertion of higher force or force for a longer period of time. Another disadvantage is that the additional force may facilitate additional substances to become part of the aggregate that are not desired.

Apparatus with interior roughness have been previously disclosed to facilitate blood clot detection in an aliquot of blood (U.S. Pat. No. 6,417,004, Brady et al., Enhancing Clot Detection in Activated Clotting Time and Other Fibrin Endpoint Based Tests). Apparatus have also been previously disclosed that can be used to separate a target substance from media, see for example, apparatus as described in USSN 20080164204 (Hatamian et al., Valve for facilitating and maintaining separation of fluids and materials), USSN 20060116270 (Hatamian et al., Centrifuge system), USSN 20090028759 (Su et al., Magnetic Separation Device), USSN 20080181824 (Brem and Rominger, Sample and Reaction Vessel), USSN 20100028896 (Noro and Miyazaki, Rotary Extraction Vessel and Method of Identifying Cell Species, Method of Detecting Gene, and Automatic Nucleic Acid Extractor Using the Same), USSN 20080213131 (Tamai et al., Particle Agglutination-Evaluating Vessel), USSN 20060281124 (Ekenberg et al. Device and Method for Purification of Biological Materials), USSN 20020012982 (Blakesley et al., Methods and compositions for rapid protein and peptide extraction and isolation using a lysis matrix), USSN 20040166589 (Fisk et al., Device for solid phase extraction and method for purifying samples prior to analysis) and USSN 20050202504 (Anderson et al., Miniaturized genetic analysis systems and methods).

Accordingly, there is a need for a better apparatus and method of using the apparatus for separating a target substance from a media containing the target substance and other substances. The invention disclosed herein is a vessel that facilitates the separation of such target substance from the media.

### BRIEF SUMMARY OF THE INVENTION

The present invention provides a vessel and methods of using the vessel for separating a target substance from the media containing one or more other substances.

In one embodiment, the vessel is a container that has a top opening (e.g., the configuration of a test tube or eppendorf tube or a multiwell plate). The top opening is capped. In another embodiment, the vessel has a top and bottom opening (e.g. the configuration of a pipette tip or a multiwell plate). The top and bottom openings may be capped.

Preferably, the inner surface of the vessel is textured in whole or in part. The textured inner surface facilitates retention of the separated substance on the inner surface of the vessel for a longer period of time relative to an untextured surface.

The present invention also provides methods of using the vessel to separate a substance from a sample (e.g. media).

### BRIEF DESCRIPTION OF THE SEVERAL VIEWS OF THE DRAWING

FIG. 1 depicts two views of a vessel with a closed bottom and a cap: A) a front view of the vessel, and B) a cross section of the vessel showing the inner wall surface with a texture.

FIG. 2 depicts two views of a vessel with an open bottom and an open top: A) a front view of the vessel, and B) a cross section of the vessel showing the inner wall surface with a texture.

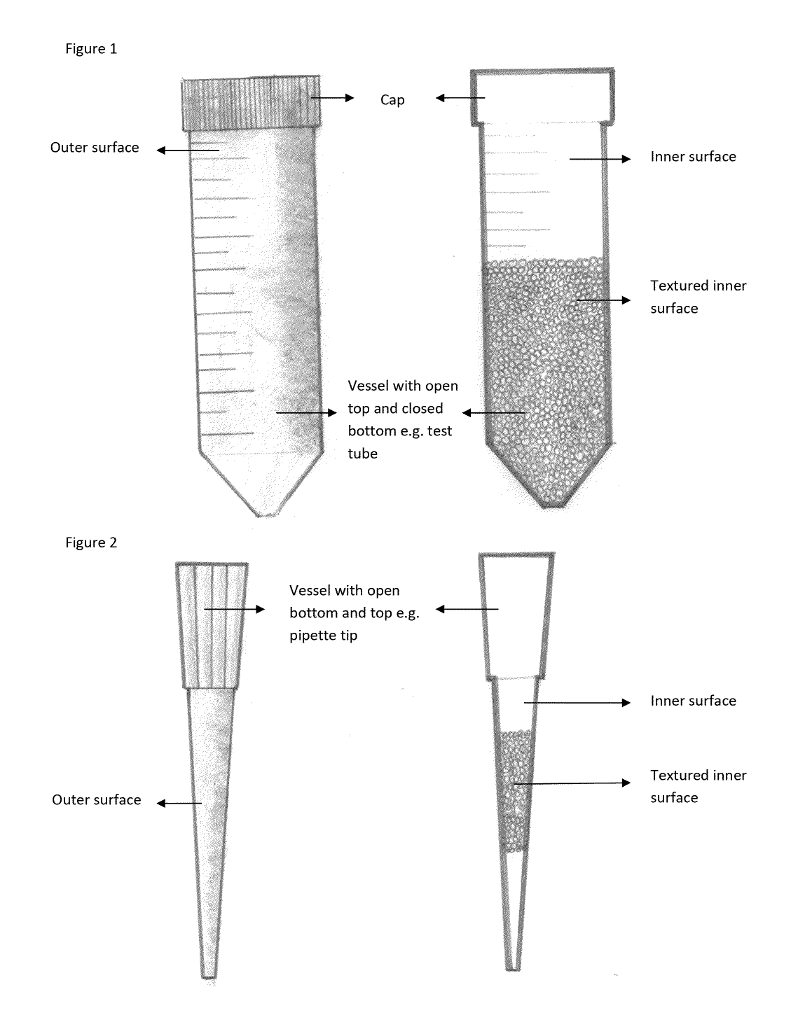

### DETAILED DESCRIPTION OF THE INVENTION

### Definitions

“About” modifies a value and means ten percent more or less than the value.
“Increased efficiency” refers to the ability of the textured vessel to better produce a desired effect compared to a control. For example, a textured test tube has increased efficiency in harvesting cells compared to a control smooth surface test tube.
“Vessel” refers to a container with a textured inner surface that can contain a sample (e.g. media). For example, the vessel can be a test tube with a cap or pipette tip with a textured inner surface. Optionally, the vessel may not comprise a lid.
“Media” refers to a liquid comprising at least two substances. For example, a media can comprise cellular components in a liquid.
“Plastic” refers to any plastic material usable to form the vessel of the invention. Examples of plastic include, but is not limited to, thermoplastic polymers e.g., polystyrene, polyethylene and polypropylene.
“Purify” means to substantially separate or isolate a substance from other substances.
“Pellet” aggregate of a substance.
“Separate” or “separation” means to isolate a substance from a mixture. For example, the vessel of the invention facilitates separation or isolation of solid cellular debris from liquid debris after cell lysis. In another example, the vessel of the invention facilitates separation or isolation of nucleic acid from a liquid containing the nucleic acid.
“Substance” refers to one or more materials present in a liquid media. A “target substance” refers to one or more materials to be isolated from the media. For example, a target substance can be nucleic acid to be separated from a media containing cellular substances after cell lysis. In another example, a target substance can be a protein to be separated from other substances in a media. In another example, a target substance can be bubbles to be separated from other substances in a media.
“Texture” or “textured” refers to a structure of the vessel described herein, wherein the structure is raised or recessed to form a pattern on the vessel. The texture of the vessel can be formed and configured in many manners including, but not limited to, the following patterns: popcorn texture, bark texture, holes, loops, hooks, weaves, mesh, ridges, fingers, indentations, dimples, hatches and the like. The texture of the vessel can comprise one or more of the preceding patterns. The texture can be located in one or more location on the vessel. For example, the vessel can have a textured region on an inner wall of the vessel, the bottom wall of the vessel, or a combination thereof.

### Embodiments of the Invention

The present invention provides a vessel and methods of using the vessel for separating a target substance from a media containing one or more different substances.

In certain embodiments, the vessel comprises a front wall portion, a rear wall portion, opposing side wall portions, a bottom wall portion, an inner surface, an exterior surface, and an open top portion, wherein a lid can cover the top portion, and wherein the inner surface is textured. In certain embodiments, the vessel can be, but is not limited to, a test tube, a well in a plate, a flask, bottle or a container. The lid can be attached to the vessel or can be detached from the vessel.

In certain embodiments, the vessel comprises a front wall portion, a rear wall portion, opposing side wall portions, an inner surface, an exterior surface, an open bottom portion, and an open top portion, wherein the inner surface is textured. In certain embodiments, the vessel can be, but is not limited to, a pipe, pipette, pipette tip or tube. In certain embodiments, a lid can cover the top portion and/or the bottom portion. The lid can be attached to the vessel or can be detached from the vessel.

In certain embodiments, the textured inner surface of the vessel comprises popcorn texture, bark texture, holes, loops, hooks, weaves, mesh, ridges, fingers, indentations, dimples, hatches and the like. In certain embodiments, the textured inner surface is located on the side, front, bottom, top and/or rear wall of the vessel. In certain embodiments, the textured inner surface is located on a lower half of the side, front or rear wall of the vessel. In certain embodiments, the textured inner surface is located on the bottom wall or top wall of the vessel.

In certain embodiments, the bottom wall portion of the vessel is conical, U shaped, flat or prism shaped.

In certain embodiments, the walls of the vessel are formed of material such as, but not limited to, polyethylene, polyethylene terephthalate, polypropylene, polypropylene copolymer (Nalgene corporation), polycarbonate, polyallomer, polystyrene, glass, borosilicate glass, pyrex® (Corning Corp., Corning, N.Y.), cellulose, cellulose propionate, stainless steel, aluminum, tin, alloys, titanium and Ultra-clear™ (Beckman Coulter Inc., Brea, Calif.) or any combination thereof. In certain embodiments, the textured surface of the vessel is formed from the same material as the walls of the vessel. In certain embodiments, the textured surface of the vessel is formed from different material as the walls of the vessel.

In certain embodiments, the vessel comprises multiple front, rear, side and bottom walls, thereby forming multiple hollow spaces with the walls. For example, the vessel can be an ELISA plate or multiple test tubes attached to each other (e.g., a PCR strip tube).

In certain embodiments, the vessel comprises multiple front, rear and side walls, thereby forming multiple hollow spaces with the walls. For example, the vessel can be multiple pipette tips attached to each other.

In certain embodiments, the invention provides a method for separating a substance from a media using the vessel of the invention. In certain embodiments, the textured inner surface of the vessel retains the separated substance on the inner surface of the vessel for a longer period of time relative to an untextured surface. In certain embodiments, the separated substance comprises cells, nucleic acids, proteins, lipids, carbohydrates, bubbles and/or colloidal materials (e.g., colloidal metals). In certain embodiments, the substance separated from the media does not contain fibrin strands. In certain embodiments, the substance separated from the media is not a blood clot.

In certain embodiments, the invention provides a test tube with a lid and textured inner surface, wherein the textured inner surface comprises polyurethane foam or popcorn texture, bark texture, holes, loops, hooks, weaves, mesh, ridges, fingers, indentations, dimples, hatches and the like. In certain embodiments, the test tube is made of polypropylene, polystyrene, polyethylene or glass. The lid can be attached to the test tube or can be detached from the test tube.

In certain embodiments, the invention provides a pipette tip with a textured surface, wherein the textured surface comprises polyurethane foam or popcorn texture, bark texture, holes, loops, hooks, weaves, mesh, ridges, fingers, indentations, dimples, hatches and the like, In certain embodiments, the pipette tip is made of polypropylene, polystyrene or polyethylene.

The vessels of the invention can be made of several different materials including, but not limited to, polymers, glass, metal, cellulose and Ultra-clear™ (Beckman Coulter Inc., Brea, Calif.). Types of polymers can include, for example, polyethylene, polyethylene terephthalate, polypropylene, polypropylene copolymer (Nalgene Corporation), polycarbonate, polyallomer and polystyrene. Types of glass can include, for example, borosilicate glass, pyrex® (Corning Corp., Corning, N.Y.) and silica. Types of cellulose can include, for example, cellulose propionate. Types of metal can include, for example, stainless steel, aluminum and metal alloys. The vessels can be coated, for example, with polytetrafluoroethylene.

Various types of lids can be used to close or seal the open top or bottom portion of the vessel. For example, types of lids include, but are not limited to, screw caps, snap caps, flip-top, dome-top, plug-seal, flat-top, plug seal cap, CentriStar™ Cap (Corning Inc., Corning, N.Y.), strip cap, heat seal closure or any device used to close or seal the opening of a vessel.

Commercially available containers can be modified to form the vessel of the invention. For example, test tubes with or without caps from Becton Dickinson Inc. (Franklin Lakes, N.J., Catalogue numbers 352070, 352073, 352074, 352077), Corning Inc. (Coming, N.Y.), Catalogue numbers 430053, 430055, 430052, 430766, 430790, 430791, 430290, 430291, 430304, 430828, 430829, 430897, 430921), P2612 Greiner® PCRmultiwell plates polycarbonate, M9530, M9655, M9780 (Corning Costar cell culture plates) or any other container manufacturer can have a texture added to the inner surface of the container to form the vessel disclosed herein.

The volume of the vessel can range from about 5 μl to 500 liters (L), about 10 μl to 100 L, about 20 μl to 50 L, about 50 μl to 20 L, about 100 μl to 10 L, about 200 μl to 5 L and about 500 μl to 1 L. The volume of the vessel can range from about 1 μl to 1 ml, about 2 μl to 500 μl, about 5 μl to 200 μl, about 10 μl to 100 μl and about 20 μl to 50 μl . The volume of the vessel can be about 1 μl, about 2 μl, about 5 μl, about 10 μl, about 20 μl , about 30 μl, about 40 μl, about 50 μl, about 60 μl, about 70 μl, about 80 μl, about 90 μl, about 100 μl, about 150 μl, about 200 μl, about 300 μl, about 400 μl, about 500 μl, about 600 μl, about 700 μl, about 800 μl, about 900 μl, and about 1000 μl. The volume of the vessel can range from about 1 ml to 1 L, about 2 ml to 900 ml, about 5 ml to 800 ml, about 10 ml to 700 ml, about 15 ml to 600 ml, about 20 ml to 500 ml, about 50 ml to 400 ml, about 80 ml to 300 ml and about 100 ml to 200 ml. The volume of the vessel can be about 1 ml, about 2 ml, about 3 ml, about 4 ml, about 5 ml, about 6 ml, about 7 ml, about 8 ml, about 9 ml, about 10 ml, about 11 ml, about 12 ml, about 13 ml, about 14 ml, about 15 ml, about 16 ml, about 17 ml, about 18 ml, about 19 ml, about 20 ml, about 25 ml, about 30 ml, about 40 ml, about 50 ml, about 60 ml, about 70 ml, about 80 ml, about 90 ml, about 100 ml, about 150 ml, about 200 ml, about 250 ml, about 300 ml, about 350 ml, about 400 ml, about 450 ml, about 500 ml, about 550 ml, about 600 ml, about 650 ml, about 700 ml, about 750 ml, about 800 ml, about 850 ml, about 900 ml, about 950 ml, and about 1000 ml. The volume of the vessel can range from about 1 L to 1000 L, about 10 L to 900 L, about 20 L to 800 L, about 50 L to 700 L, about 100 L to 600 L, about 200 L to 500 L and about 300 L to 400 L. The volume of the vessel can be about 1 L, about 1.5 L, about 2 L, about 3 L, about 4 L, about 5 L, about 6 L, about 7 L, about 8 L, about 9 L, about 10 L, about 11 L, about 12 L, about 13 L, about 14 L, about 15 L, about 20 L, about 30 L, about 40 L, about 50 L, about 75 L, about 100 L, about 150 L, about 200 L, about 250 L, about 300 L, about 350 L, about 400 L, about 450 L, about 500 L, about 550 L, about 600 L, about 650 L, about 700 L, about 750 L, about 800 L, about 850 L, about 900 L, about 950 L and about 1000 L.

The size of the vessel will be commensurate with the volume of the vessel. For example, a vessel with a 5 ml volume can be about 12 mm (diameter)×75 mm (length) in size, a vessel with an 8 ml volume can be about 13 mm (diameter)×100 mm (length) in size, a vessel with a 14 ml volume can be about 17 mm (diameter)×100 mm (length) in size, a vessel with a 15 ml volume can be about 118.54 mm (length)×17.53 mm (diameter at the top)×15.62 mm (diameter at the bottom) in size, a vessel with a 16 ml volume can be about 16 mm (diameter)×125 mm (length) in size, a vessel with a 19 ml volume can be about 16 mm (diameter)×150 mm (length) in size and a vessel with a 50 ml volume can be about 114.35 mm (length)×29.13 mm (diameter at the top)×28.14 mm (diameter at the bottom) or 114.94 mm (length)×29.13 mm (diameter at the top)×27.93 mm (diameter at the bottom) in size.

The inner surface of the vessel can be formed or configured in various ways including, but not limited to, the following patterns: popcorn texture, bark texture, holes, loops, hooks, weaves, mesh, ridges, fingers, indentations, dimples, hatches and the like.

The textured inner surface can be formed as an extension of the material forming the vessel, for example, by pressure molding, stamping, etching or embossing an inner wall area of the vessel. Stamping can be done by applying force or heat or a combination of the two to form the texture. A die can be used to make the physical characteristics of the texture. Etching can be done chemically or physically. Physical formation of the texture can be done using a tool such as a vibrating tool, grinding tool, or sanding tool.

The textured inner surface can be formed by adding material to an inner wall surface of the vessels, for example, by adding a foam, mesh, bristles, batting, loops or hooks to the inner wall. For example, the foam can be sprayed on an inner surface of the vessel to form a texture. Different types of foam spray are commercially available (www.sprayfoam.org). Flexible polyurethane foam is manufactured as a product of the reaction of two key raw materials, a polyol and a diisocyanate with water. When the raw materials are combined, the reaction forms bubbles and the mixture expands to produce a solid foam texture on the inner surface of the vessel. In another example, a textured material such as, but not limited to, mesh, netting, batting, bristles, loops or hooks (e.g., Velcro™) can be adhered to an inner wall of the vessel to produce the textured surface.

The textured inner surface of the vessel is designed to trap a target substance and separate it from the surrounding media. The target substance can be forced towards the textured inner surface of the vessel by the use of centrifugal force, magnetic force, electric force or by affinity binding. The target substance becomes trapped on the textured surface such that when the force is removed the substance remains trapped on the textured surface. After the target substance is trapped to the textured surface, the media can be removed from the vessel, substantially purifying the target substance. Alternatively, the textured surface with the trapped substance can be removed from the vessel, substantially purifying the target substance. In one example, after cells contained in a vessel of the invention are lysed, the vessel with the cellular material is centrifuged to aggregate the target substance (i.e., the solid cellular debris) on the textured surface of the vessel. The liquid faction of the lysed cell can then be removed from the vessel, substantially separating the target substance from the liquid media. In another example, the liquid media separated from solid cellular debris is placed in a vessel of the invention. The liquid media can then be treated by art known methods (Sambrook, 2001, Molecular Cloning: A Laboratory Manual, 3^{rd} Ed., CSHL Press, Woodbury, N.Y.) so that the nucleic acid portion of the liquid media is precipitated into solid form. The vessel is centrifuged to aggregate the target substance (i.e., the nucleic acid) on the textured surface of the vessel. The liquid faction is then removed to substantially purify the nucleic acid. In yet another example, the target substances are bubbles in an emulsion that can be trapped by the textured surface.

The whole inner surface of the vessel can be textured or a portion of the inner surface of the vessel can be textured. The textured portion of the inner wall can be located at various sites. For example, the texture can be located at about the top quarter of the vessel, the top third of the vessel, the top half of the vessel, the top three quarters of the vessel or the top two thirds of the vessel. In another example, the texture can be located at about the bottom quarter of the vessel, the bottom third of the vessel, the bottom half of the vessel, the bottom three quarters of the vessel or the bottom two thirds of the vessel. In another example, the texture can be located at about the middle quarter of the vessel, the middle third of the vessel, the middle half of the vessel, the middle three quarters of the vessel or the middle two thirds of the vessel. The textured surface can be located on any one or more walls of the vessel at any position. For example, the bottom wall and the lower half of the front wall of the vessel can be textured or the texture can be located at the middle half of a side wall of the vessel.

### Advantages of the Invention

The present invention provides a vessel with a textured inner surface to facilitate separation of a substance from a media. Advantages of the invention include, but are not limited to, a decrease in the time required to separate the substance from the media or a decrease in the energy or force required to separate the substance from the media. Advantages of the invention also include providing a stable aggregate of the substance to facilitate its removal from the media. A decrease in time and energy and an increase in ease of use can decrease costs associated with separating a substance from a media. Accordingly, the invention provides a faster, more efficient and cost effective method for separating a substance from a media.

### EXAMPLES

While compositions of the present invention have been described with specificity in accordance with certain embodiments, the following examples serve only to illustrate the compositions of the invention and are not intended to limit the same. Each of the references recited in the present application is incorporated herein by reference in its entirety

### Example 1

### Adhesion of Cells to the Inner Surface of a Vessel of the Invention

### Materials and Methods

A 50 ml test tube (Corning, Corning, N.Y. Catalogue No. 430828) was modified by adhering with Superglue® (Henkel Corp., Avon, Ohio) a strip of polyurethane foam (Pre Wrap Taping, Mitre Sports Intl., London, UK) to the bottom and lower one third of the test tube to form a textured inner surface. The textured test tube and an unmodified test tube (i.e. smooth surface) control were used to determine the adhesion of yeast cells to the inner surface of the test tubes after centrifugation.

Baker's yeast (Saccharomyces cerevisiae) cells were grown by adding 7 grams of Fleischmann's Rapid Rise Yeast to a solution of 500 mL water and 5 grams sucrose overnight at room temperature. 10 ml of the sucrose solution with suspended yeast cells were added to each of the textured and control test tubes. The test tubes were centrifuged at 2000×g for 2 minutes to form a pellet of cells in the lower one third portion of each test tube. The test tubes were turned upside down to decant the sucrose solution from the test tubes and allow the pellet to slip down the inner surface of the test tubes.

### Results

The pellet in the control test tube fragmented and flowed down the inner surface of the control tube in less than 2 minutes. The pellet in the textured test tube remained intact and did not slip down the inner surface of the textured test tube even after 12 hours.

### Example 2

### Nucleic Acid Separation from Cells Using Centrifugal Force

Nucleic Acids are routinely purified from leucocytes in human blood for a variety of tests. In order to isolate and purify this nucleic acid from blood, the protocol described in Gentra Puregene Handbook 09/2007 20 (Qiagen, Chatsworth, Calif., USA) can be modified for use with the vessel of the invention.

### Materials and Methods

A 50 ml test tube will be modified by adhering with Superglue® (Henkel Corp., Avon, Ohio) a strip of polyurethane foam (Pre Wrap Taping, Mitre Sports Intl., London, UK) to the bottom and lower one third of the test tube to form a textured inner surface. The textured test tube and an unmodified test tube control will then used in the nucleic acid purification protocol described below.

Dispense 30 ml RBC Lysis Solution into a 50 ml centrifuge tube having a textured surface on the inside of the tube and the 50 ml test tube control. Add 10 ml whole blood or bone marrow, and mix by inverting 10 times. Incubate 5 min at room temperature (15-25° C.). Invert at least once during the incubation. For fresh blood (collected within 1 h before starting the protocol), increase incubation time to 3 min to ensure complete red blood cell lysis. Centrifuge for 2 min at 2000×g to pellet the white blood cells. Carefully discard the supernatant by pipetting or pouring, leaving approximately 200 μl of the residual liquid and the white blood cell pellet. Vortex the tube vigorously to resuspend the pellet in the residual liquid. Vortexing greatly facilitates cell lysis in the next step. The pellet should be completely dispersed after vortexing. Add 10 ml Cell Lysis Solution, and pipet up and down to lyse the cells or vortex vigorously for 10 s. Usually no incubation is required; however, if cell clumps are visible, incubate at 37° C. until the solution is homogeneous. Samples are stable in Cell Lysis Solution for at least 2 years at room temperature. Optional: If RNA-free DNA is required, add 50 μl RNase A Solution, and mix by inverting 25 times. Incubate for 15 min at 37° C. Then incubate for 3 min on ice to quickly cool the sample. Add 3.33 ml Protein Precipitation Solution, and vortex vigorously for 20 s at high speed. Centrifuge for 5 min at 2000×g. The precipitated proteins should form a tight, dark brown pellet. If the protein pellet is not tight, incubate on ice for 5 min and repeat the centrifugation. Pipet 10 ml isopropanol into a clean 50 ml tube and add the supernatant from the previous step by pouring carefully. Be sure the protein pellet is not dislodged during pouring. Mix by inverting gently 50 times until the DNA is visible as threads or a clump. Centrifuge for 3 min at 2000×g. The DNA may be visible as a small white pellet. Carefully discard the supernatant, and drain the tube by inverting on a clean piece of absorbent paper, taking care that the pellet remains in the tube. Add 10 ml of 70% ethanol and invert several times to wash the DNA pellet. Centrifuge for 1 min at 2000×g. Carefully discard the supernatant. Drain the tube on a clean piece of absorbent paper, taking care that the pellet remains in the tube. Air dry the pellet for 10-15 min. The pellet might be loose and easily dislodged. Avoid over-drying the DNA pellet, as the DNA will be difficult to dissolve. Add 1 ml DNA Hydration Solution and vortex for 5 s at medium speed to mix. Incubate at 65° C. for 1 h to dissolve the DNA. Incubate at room temperature overnight with gentle shaking. Ensure tube cap is tightly closed to avoid leakage. Samples can then be centrifuged briefly and transferred to a storage tube. The use of 50 ml tubes containing the textured surface in this application provides a secure surface for the pellet to adhere to during the centrifugation process such that when the liquid is removed, the pellet is held to the inner surface for a longer time than if the textured surface was not present.

### Example 3

### Nucleic Acid Separation from Cells with Magnetic Force

Magnetic beads in solution are commonly used to purify nucleic acids. The following is an example of a commercial nucleic acid purification protocol using magnetic beads (Protocol 000387v001 AGENCOURT® AMPURE® XP PCR PURIFICATION, Agencourt Bioscience Corporation, Beverly, Mass., www.agencourt.com/technical) that can be modified to use the vessel of the invention. In this example, the vessel of the invention will be a 96 well reaction plate with a textured inner surface on a wall in each well.

### Materials and Methods

A 96 well plate with a textured surface on the bottom and lower one third of each well will be used in the nucleic acid purification protocol below.

Determine whether or not a plate transfer is necessary. If the PCR reaction volume multiplied by 2.8 exceeds the volume of the PCR plate, a transfer to a 300 μL round bottom plate will be required. Gently shake the Agencourt AMPure XP bottle to resuspend any magnetic particles that may have settled. Add Agencourt AMPure XP according to the PCR reaction volume chart below:

| PCR Reaction Volume (μL) | AMPure XP Volume (μL) |
|---|---|
| 10 | 18 |
| 20 | 36 |
| 50 | 90 |
| 100 | 180 |

The volume of Agencourt AMPure XP for a given reaction can be derived from the following equation: (Volume of Agencourt AMPure XP per reaction)=1.8×(Reaction Volume)

Mix reagent and PCR reaction thoroughly by pipette mixing 10 times. Let the mixed samples incubate for 5 minutes at room temperature for maximum recovery. This step will bind PCR products 100 bp and larger to the magnetic beads. Pipette mixing will be preferable as it tends to be more reproducible. The color of the mixture should appear homogenous after mixing. Place the reaction plate (i.e. the vessel with the textured surface) onto an Agencourt SPRIPIate 96 Super Magnet Plate for 2 minutes to separate beads from the solution. Wait for the solution to clear before proceeding to the next step. Due to the textured inner surface of the well the magnetic beads will be held more securely in place. The following wash steps will perform better because the beads will be held more securely to the inner surface of the palate due to the textured surface that physically trap the beads. Aspirate the cleared solution from the reaction plate and discard. Dispense 200 μL of 70% ethanol to each well of the reaction plate and incubate for 30 seconds at room temperature. Aspirate out the ethanol and discard. Repeat for a total of two washes. Do not disturb the separated magnetic beads. Be sure to remove all of the ethanol from the bottom of the well as it is a known PCR inhibitor. A dry time of ≦5 min at Room Temperature will be optional to ensure all traces of ethanol will be removed but take care not to over dry the bead ring (bead ring appears cracked) as this will significantly decrease elution efficiency. Take off the magnetic plate, add 40 μL of elution buffer (Reagent grade water, TRISAcetate pH 8.0, or TE) to each well of the reaction plate and pipette mix 10 times. Mix thoroughly to mix the beads into the solution. The liquid level will be high enough to contact the magnetic beads at a 40 μL elution volume. A greater volume of elution buffer can be used, but using less than 40 μL will require extra mixing (to ensure the liquid comes into contact with the beads) and may not be sufficient to elute the entire PCR product. Elution is quite rapid and it is not necessary for the beads to go back into solution for it to occur. Place the reaction plate onto an Agencourt SPRIPlate 96 Super Magnet Plate for 1 minute to separate beads from the solution. Transfer the eluant to a new plate. The eluant so obtained will be have fewer magnetic beads and will be a cleaner eluate.

### Example 4

### Metal Separation from Ore by Centrifugal Force

Extraction of precious metal from ore requires the separation of colloidal material during the extraction process. These colloidal materials can be separated from the liquid by centrifugation. The pellet obtained during this process contains the metal.

The centrifugation vessel with the textured surface will better trap the pellet and will therefore increase the efficiency of extraction compared to a vessel without a textured inner surface.

Extraction of the precious metal will be performed according to art known methods in the vessel of the invention.

### Example 5

### Separation of a Target Substance with Affinity Binding

### Materials and Methods: Enzyme-Linked Immunosorbent Assay (ELISA)

A commercially available ELISA plate (for example, NUNC MaxiSorp™ High Protein-Binding Capacity ELISA plate, Catalogue No. 44-2404, eBiosource Inc., San Diego, Calif.) will be modified by physically etching a texture on the inner surface in each well. An unmodified ELISA plate will be used as a control.

The ELISA plates containing textured wells and smooth wells will be coated with antibodies according to art known methods. The plates will be processed with art known methods such that it can be used to isolate, purify or detect the bound antigen (Sambrook, 2001, Molecular Cloning: A Laboratory Manual, 3^{rd} Ed., CSHL Press, Woodbury, N.Y.).

### Results

The plate with the textured surface will provide increased surface area to coat with antibodies, allowing for an increased amount of antigens to bind to the antibody coated wells, compared to the control plate. The plate with the textured surface will provide an increase in the amount of antigen purified from the textured plate or an enhanced detection of the bound antigen to the textured plate.

### Example 7

### Separation of Blood Cells from Total Blood

Seperation of Blood cells requires centrifugation of the blood. The pellet obtained contains the cells.

### Materials and Methods

A 50 ml test tube (Coming, Corning, N.Y. Catalogue No. 430828) was modified by adhering a 2 sq cm of Scotch fastners RF7030 (3M, St. Paul, Minn.) to the bottom and lower one third of the test tube to form a textured inner surface. The textured test tube and an unmodified test tube (i.e. smooth surface) control were used to determine the adhesion of blood cells and particles to the inner surface of the test tubes after centrifugation.

50 μl of venous blood was mixed with 10 ml of TE buffer (10 mM Tris 1 mM EDTA pH 7.0) in the textured or unmodified 50 ml test tubes mentioned above.

The test tubes were centrifuged at 3500×g for 10 minutes in a fixed angle centrifuge (Heraeus Biofuge stratos, Thermofisher, Waltham, Mass.) to form a pellet of cells in the lower one third portion of each test tube. The test tubes were placed in such a way that the textured surface was toward the outside of the angle of the rotor. After centrifugation, the medium in the tube was discarded and fresh 10 ml TE buffer was added. In order to measure the pelleted material, both the tubes were centrifuged at 3500×g for 3 min with the test tubes turned 180 degrees from the previous orientation (i.e. with the textured surface towards the inside of the angle of the rotor). The tube was then vortexing for 5 seconds to dissolve the pellet in solution.

In order to quantitate the pelleted material in the suspensions derived from the textured and smooth test tubes, 50 ul of suspension media from each test tube was mixed with 10 ml of Z2 particle counter diluent (Beckman Coulter, Brea, US). This mixture from each tube was counted on a Z2 cell and particle counter per the manufacturer's recommended protocol (Beckman Coulter, Brea, US).

### Results

The average of 3 independent readings of the particles in the control (smooth) test tube as well as the textured surface tube were taken by the Z2 cell and particle counter counter. The number of particles derived from the experimental test tube containing the textured surface was over 28 fold higher than the number of particles derived from the control smooth surface test tube. The increased efficiency of the textured surface test tube to capture particles compared to smooth surface test tubes has many potential benefits such as: increasing the number of cells captured per aliquot of blood; decreasing the amount of blood needed to harvest a specific amount of cells; decreasing the amount of reagents needed to harvest a specific amount of cells; decreasing the vessel (or other device) size needed to harvest a specific amount of cells; decreasing the centrifugation force needed to harvest a specific amount of cells; decreasing the centrifugation time needed to harvest a specific amount of cells; and decreasing the damage to the cells during centrifugation due to the gentler conditions that can be used to pellet the cells.

1. A vessel comprising
a) a front wall portion,
b) a rear wall portion,
c) opposing side wall portions,
d) a bottom wall portion,
e) an inner surface,
f) an exterior surface, and
g) an open top portion,
wherein a lid covers the top portion, and wherein the inner surface is textured.

2. The vessel of claim 1, wherein the vessel is a test tube, a well in a plate, a flask, bottle or a container.

3. The vessel of claim 1, wherein the lid is attached to the vessel or is not attached to the vessel.

4. The vessel of claim 1, wherein the textured inner surface comprises popcorn texture, bark texture, holes, loops, hooks, weaves, mesh, ridges, fingers, indentations, dimples or hatches.

5. The vessel of claim 4, wherein the textured inner surface is located on the side, front, bottom, top or rear wall of the vessel.

6. The vessel of claim 4, wherein the textured inner surface is located on a lower half of the side, front or rear wall of the vessel.

7. The vessel of claim 4, wherein the textured inner surface is located on the bottom wall or top wall of the vessel.

8. The vessel of claim 1, wherein the walls of the vessel are formed of but not limited to polyethylene, polyethylene terephthalate, polypropylene, polypropylene copolymer, polycarbonate, polyallomer, polystyrene, glass, borosilicate glass, pyrex®, cellulose, cellulose propionate, stainless steel, aluminum, tin, alloys, titanium and Ultra-clear™ or any combination thereof.

9. The vessel of claim 8, wherein the textured surface of the vessel is formed from the same material as the walls of the vessel.

10. The vessel of claim 8, wherein the textured surface of the vessel is formed from different material as the walls of the vessel.

11. The vessel of claim 1, wherein the vessel comprises multiple front, rear, side and bottom walls, thereby forming multiple hollow spaces with the walls.

12. The vessel of claim 1, wherein the bottom wall portion is conical, U shaped, flat or prism shaped.

13. A method of separating a substance from a media using the vessel of claim 1.

14. The method of claim 13, wherein the textured inner surface retains the separated substance on the inner surface of the vessel for a longer period of time relative to an untextured surface.

15. The method of claim 13, wherein the substance comprises cells, nucleic acids, proteins, lipids, carbohydrates, bubbles and colloidal materials.

16. The method of claim 13, wherein the substance separated from the media does not contain fibrin strands.

17. The method of claim 13, wherein the substance separated from the media is not a blood clot.

18. The method of claim 13, wherein the separated substance is isolated from the media.

19. A test tube with a lid and textured inner surface, wherein the textured inner surface comprises polyurethane foam, popcorn texture, bark texture, holes, loops, hooks, weaves, mesh, ridges, fingers, indentations, dimples or hatches, and wherein the test tube is made of polypropylene, polystyrene, polyethylene or glass.

20. A pipette tip with a textured surface, wherein the textured surface comprises polyurethane foam, popcorn texture, bark texture, holes, loops, hooks, weaves, mesh, ridges, fingers, indentations, dimples or hatches, and wherein the pipette tip is made of polypropylene, polystyrene or polyethylene.
